(19) United States
(12) Patent Application Publication
(10) Pub. No.: US 2005/0241000 A1
(43) Pub. Date: Oct. 27, 2005

(54) Security hole diagnostic system

(76) Inventor: Kiyoto Kawauchi, Tokyo (JP)

Correspondence Address: BIRCH STEWART KOLASCH & BIRCH, PO BOX 747, FALLS CHURCH, VA, 22040-0747, US

(21) Appl. No.: 10/501,239

(22) PCT Filed: Oct. 8, 2003
(86) PCT No.: PCT/JP03/12914

§ 371 Date: Jul. 12, 2004

(30) Foreign Application Priority Data
Oct. 22, 2002 (JP) 2002-306536

(51) Int. Cl. G06F 12/14; G06F 11/30; H04L 9/32; H04L 9/00

(52) U.S. Cl. 726/25; 726/22

(57) ABSTRACT

Scripts describing procedures usually used by attackers in a programming language are pre-accumulated. A script selected by the user out of the accumulated scripts is executed, which calls a plugin with logic implemented for attacking each security hole. This plugin is executed on a test target computer, which allows removing the necessity of the user having security knowledge about such as input/output relationship between test execution units.

### TECHNICAL FIELD

The present invention relates to a system for diagnosing the presence of security holes on computers.

### BACKGROUND ART

FIG. 9 shows the block diagram of a conventional security hole diagnostic system that is typified by Japanese Unexamined Publication No. 2001-337919 (pages 4 to 8, FIGS. 3, 4, and 14). The conventional system includes an operation device 900 and a test execution device 907. The operation device 900 includes a display 902, a screen generation unit 903, an operation control unit 905, a display name definition file 904, and a procedure definition file 906.

And the test execution device 907 includes an execution control unit 908, a target host information storage unit 909, a plurality of test execution means 911, and a test execution means storage unit 910.

FIG. 10 shows an example of the procedure definition file 906 of the same system. The procedure definition file 906 has a description of the category key name of the test execution means 911 and the display name, execution type and explanation for each property value of the test execution means 911 specified as a category key.

FIG. 11 shows information about the test execution means 911 (test execution information) of the same system. The test execution information includes a value (property) that characterizes each test execution means 911 stored in associations with its key name (property name). More particularly, the test execution information (information about the test execution means), which is included in each test execution means, is information (=profile) that characterizes its test execution means. The test execution information may include descriptions of multiple items (properties). Each item is distinguished from others by the property name.

Now, the operation of the conventional system will be described. The operation device 900, when connected to the test execution device 907, loads the display name definition file 904 and the procedure definition file 906.

Then, the operation device 900 retrieves the test execution information from each test execution means 911 accumulated in the test execution means accumulation unit 910 in the test execution device 907, and classifies the test execution means 911 into categories described in the procedure definition file 906 based on the property corresponding to the key name specified in the procedure definition file 906. Finally, the operation device 900 displays on the display 902 a list of classified test execution means 911 for each category.

A user 101 selects a category displayed on the display 902, inputs a parameter required for execution, and calls for executing a test. Information described in the display name definition file 904 is used for an explanation of the parameter. The operation device 900, upon request to execute the test, requests the test execution device 907 via the operation control unit 905 to execute the test execution means 911 classified in that category.

The test execution device 907 calls the test execution means 911 specified, and consequently a packet for test is transmitted to a test target host computer 107.

It is to be noted that each test execution means 911 is capable of storing information in the target host information storage unit 909, and stored information can be referred to by other test execution means 911. It is also possible that the user 101 stores information directly in the target host information storage unit 909 via the operation device 900.

That explains the flow of a test according to the conventional system. It is to be noted here that the display order of the categories follows the order of the categories listed in the procedure definition file 906. Therefore, by making the order conform with general attack procedures, then the user 101 is allowed conducting a test simulating an attacker by following the order shown on the display 902.

As aforementioned, the conventional security hole diagnostic system has the plurality of test execution means. They are classified/displayed based on the method given in the procedure definition file, and the user selects one for each category, which executes the test execution means of that category. In addition, the test execution means is one that executes a test directly on a test target host computer. For those reasons, it has posed problems as follows.

It is requested that the user enters an execution parameter, which is to be entered for each category, based on the previous test result. This requires the user to grasp relationship between the test result of one category and an entry to another category. This requests the user to have security knowledge.

The definition file is capable of describing nothing but the scenario of a serial execution. In many cases, however, real attackers vary the types of attacks based on results from previous attacks. With the conventional system, it is the user to determine which category to be tested next. This also requires the user to have security knowledge.

Attackers carry out attacks that are constructed with complicated steps for certain purposes. It may be assumed that such a chain of attacks is only one step in an attack scenario for achieving a bigger goal. The conventional system is not capable of describing such a hierarchized attack scenario.

There is no deduction means of deducting other information from the information accumulated in the target host information storage unit. It is a means of deriving the knowledge, for example, that the account name of the administrator is “root” from the information that the OS of the target host is UNIX (registered trade mark). This means that each test execution means has to have logic buried therein to be used for deducting required information from accumulated information.

Attackers, in many cases, once they made a successful invasion into a host, try to reach inside from there as a springboard. However, the conventional test system, which executes a test directly from the test execution means, cannot carry out a test scenario using a springboard.

The present invention is directed to solving the problems discussed above, has objectives as follows.

A test scenario is described as a script in a programming language, and a plugin (corresponding to the test execution means) is called automatically from the script. This allows executing a complicated test.

Parameters are exchanged through the script between the test execution means. This allows removing the necessity of the user having knowledge about input/output relationship between test execution means.

It is made possible to conduct a security hole diagnostic test with a more real and sophisticated attack scenario. This allows lowering the level of security knowledge required for the user, and reducing load on test logic creators.

### DISCLOSURE OF THE INVENTION

A security hole diagnostic system according to the present invention includes:
a script accumulation unit accumulating a plurality of scripts in a programming language describing procedures usually used by attackers for illegal access;
an operation unit making a request for a list of the plurality of scripts upon entry from a user;
a script control unit retrieving each script from the script accumulation unit upon the request from the operation unit, creating a list of an input/output parameter, a script execution condition and a test procedure described thereof, and presenting the list to the user, and executing a script that is selected by the user;
a plugin accumulation unit accumulating plugins with logics for attacking individual security holes; and
a plugin control unit, which is called by an execution of the script by the script control unit, for retrieving from the plugin accumulation unit a plugin that is specified by the script to be executed and executing the plugin on a test target computer.

### BRIEF DESCRIPTION OF THE DRAWINGS

FIG. 1 is a schematic block diagram of a security hole diagnostic system according to a first embodiment.

FIG. 2 is an internal block diagram of a vulnerability test unit shown in FIG. 1.

FIG. 3 is an internal block diagram of a springboard simulation program shown in FIG. 1.

FIG. 4 is an explanatory diagram of a script structure.

FIG. 5 is an operational flow diagram of a script control unit.

FIG. 6 is an operational flow diagram in the case where a test is executed with a class name specified.

FIG. 7 is an explanatory diagram of an example of a knowledge file.

FIG. 8 is an explanatory diagram of an example of a script description.

FIG. 9 is a block diagram of a conventional security hole diagnostic system.

FIG. 10 is an explanatory diagram of a procedure definition file according to the conventional system.

FIG. 11 is an explanatory diagram of information about a test execution unit (test execution information) according to the conventional system.

### BEST MODE FOR CARRYING OUT THE INVENTION

### Embodiment 1

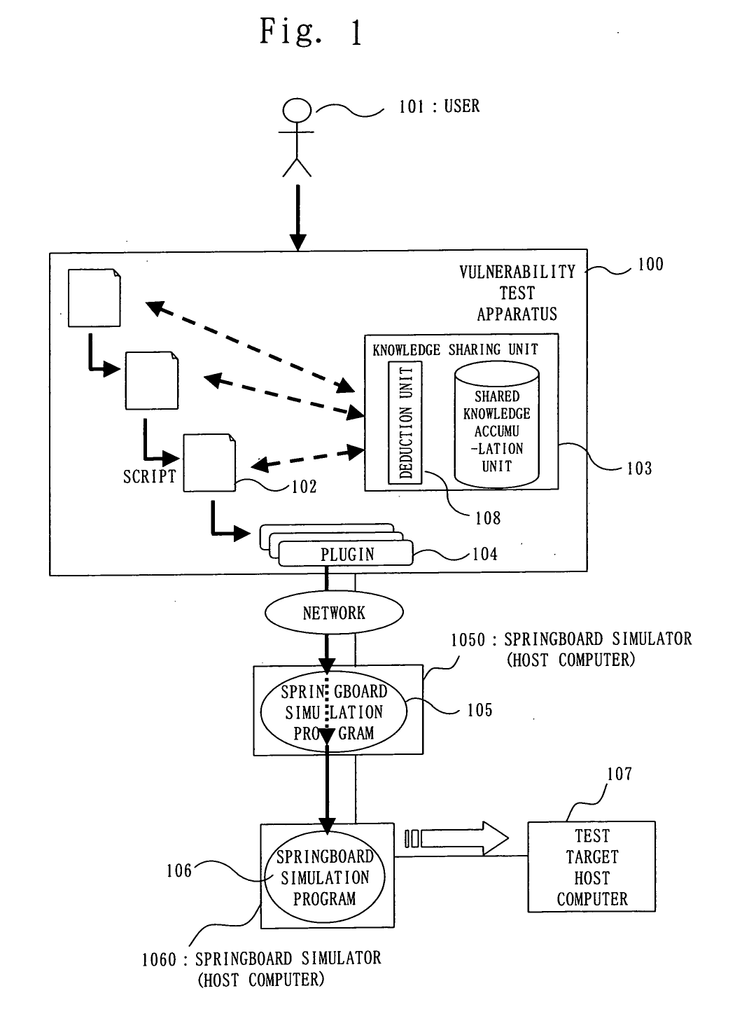

Firstly, the present system will be outlined with reference to FIG. 1. The present system includes a vulnerability test apparatus 100, which operates locally, and one or more springboard simulators, which is a remote or local host computer. This embodiment includes two springboard simulators 1050 and 1060 installed. The vulnerability test apparatus 100 and the springboard simulators 1050 and 1060 are connected, respectively, over a network. More specifically, the springboard simulator 1050, 1060 executes a springboard simulation program 105, 106, respectively.

The vulnerability test apparatus 100 is a computer that tests a host computer or network as a target to see whether or not it contains security vulnerability, in response to a request from a user 101. The test is executed by the vulnerability test apparatus 100 that operates the springboard simulation program of the springboard simulator 1050.

The springboard simulation program 105 executed by the springboard simulator 1050 is a program that receives commands from the vulnerability test apparatus 100 over the network, transmits/receives a packet, starts/ends a process, transfers a file, and relays a message.

The springboard simulation program 105 also has a function to transfer a command to the springboard simulation program 106 of the other springboard simulator 1060. If the springboard simulator 1050, 1060 is disposed adequately, then even a test target host computer 107 that is installed in an internal-network can be tested.

The springboard simulation program 105, 106 can either be kept operating in a host on a test target network before the test is executed, or embedded as part of a vulnerability test by use of a security hole.

More specifically, the operation of the springboard simulation program 105 is controlled by a plugin 104 in the vulnerability test apparatus 100. The plugin 104 is a dynamically loadable shared library for attacking each security hole. The plugin 104 attacks a security hole on a test target by using the springboard simulation program 105.

If a wide variety of plugins 104 are available, a wide variety of vulnerability tests for security holes then become available.

The plugin 104 is controlled by a script 102. The script 102 is text data in an interpreter language that describes procedures attackers usually use for illegal access. The vulnerability test apparatus 100 can conduct complicated vulnerability tests with simulation of attackers by calling various plugins 104 based on the script 102.

As with the plugin 104, a plurality of scripts 102 may be available for different purposes. It is also possible to call one script 102 from another script 102, which allows describing more sophisticated script 102 which uses another script 102 as one step in an attack.

With this embodiment, Perl is used as a description language of the script 102.

By means of the script 102, knowledge about a test target obtained as a result of a test executed, e.g., information such as a list of user accounts or a list of operating servers, can be accumulated in a knowledge sharing unit 103. Knowledge accumulated in the knowledge sharing unit 103 is available for reference for another script 102.

In addition, if the knowledge sharing unit 103 has a deduction unit 108 for examining knowledge based on deduction rules, new knowledge (deduction) can be derived from knowledge (factual information) obtained from the script 102. For instance, if it is determined by one script 102 that the OS of the test target host computer 107 is a UNIX (registered trade mark) family, then the knowledge that the administrator account name of the host is “root” can be derived based on the deduction rules.

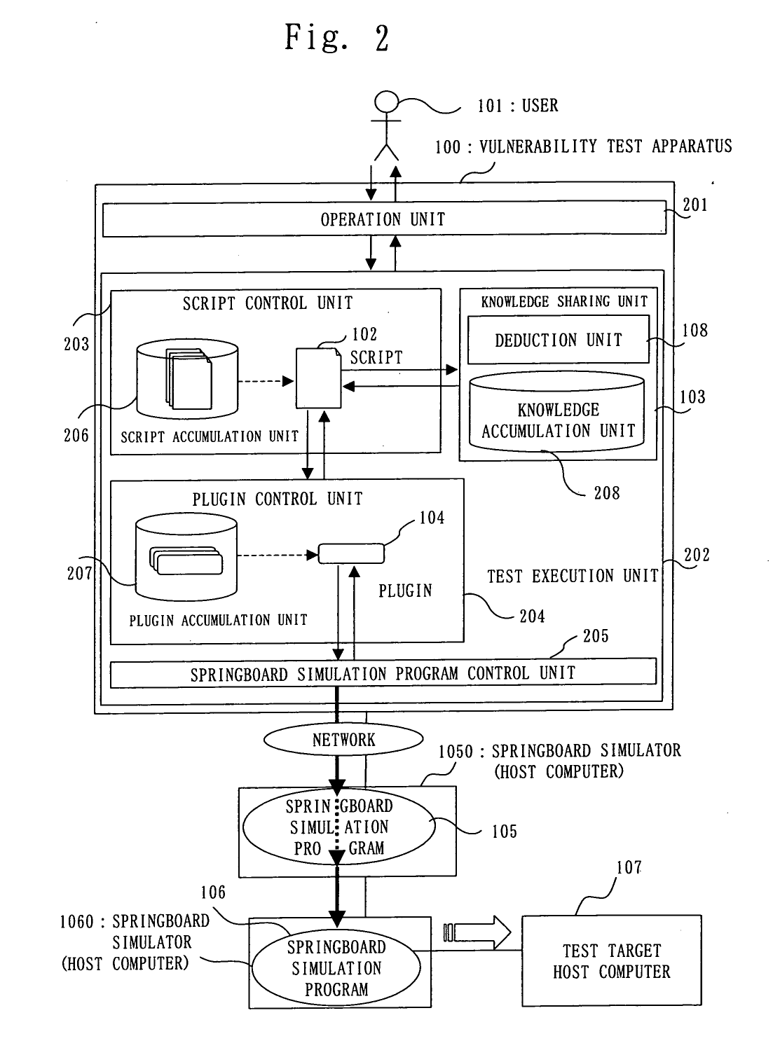

Based on the general outline discussed above, an inner configuration of the vulnerability test apparatus 100 will be discussed with reference to FIG. 2. The vulnerability test apparatus 100 includes an operation unit 201 and a test execution unit 202. The test execution unit 202 includes a script control unit 203, a plugin control unit 204, a knowledge sharing unit 103, and a springboard simulation program control unit 205.

The script control unit 203 provides a means of accumulating, browsing, and executing the scripts 102. One or more scripts 102 are accumulated in a script accumulation unit 206 disposed within the script control unit 203. The script 102 is managed in the script accumulation unit 206 under a unique name assigned by the file name. More specifically, the script accumulation unit 206 is a magnetic disk, for example.

The script 102, as shown in FIG. 4, is constructed with a class name description unit 401, an execution condition description unit 402, an input/output parameter description unit 403, an explanation description unit 404, and a test procedure description unit 405.

The class name description unit 401 has data describing which category's test the script 102 should belong to. The execution condition description unit 402 has a description of conditions to be met for executing a script. The conditions are described based on predicate calculus. The input/output parameter description unit 403 has a description of what input the script 102 should receive and what output it should produce. The explanation description unit 404 has a description of a descriptive text of the script 102. The test procedure description unit 405 has a description of test procedures.

FIG. 8 shows an example of how the script 102 is described. In the figure, “Class:” represents the class name description unit 401, “Precondition:” represents the execution condition description unit 402, and “Input;” and “Output:” each represent the input/output parameter description unit 403. “Description:” represents the explanation description unit 404 and a Perl code as the test procedure description unit 405 is described below “#-----END_SCRIPT_PROPERTY-----”.

The plugin control unit 204 includes a plugin accumulation unit 207 in which one or more plugins 104 are accumulated. The plugin accumulation unit 207 is a magnetic disk, for instance. The plugin 104 is managed under a unique name assigned in the plugin accumulation unit 207.

The knowledge sharing unit 103 is a means of allowing knowledge collected by one script 102 in the process of a vulnerability test to be shared with other scripts 102.

The knowledge sharing unit 103 includes a knowledge accumulation unit 208 in which knowledge collected in the process of a vulnerability test are accumulated. The knowledge accumulation unit 208 is a magnetic disk, for instance. The knowledge sharing unit 103 also includes a deduction unit 108 in which deduction process may be carried out based on knowledge within the knowledge accumulation unit 103. It is also possible as part of the deduction process to execute the script 102 through the script control unit 203.

The springboard simulation program control unit 205 provides the plugin 104 with an interface for controlling the springboard simulation program 105, and also manages the state of the springboard simulation program 105 in operation.

It is to be noted that the vulnerability test apparatus 100 may be implemented by a computer equipped with a CPU such as a microprocessor, a storage means such as a semi-conductor memory or a magnetic disk, and a communication means, for instance. The knowledge sharing unit 103, the script control unit 203, the plugin control unit 204 and the springboard simulation program control unit 205 in FIG. 2 may be implemented by programs (vulnerability test programs), the vulnerability test programs may be stored in the storage means, so that the CPU reads the vulnerability test programs to control the operation of the vulnerability test apparatus 100 and to implement the process given below.

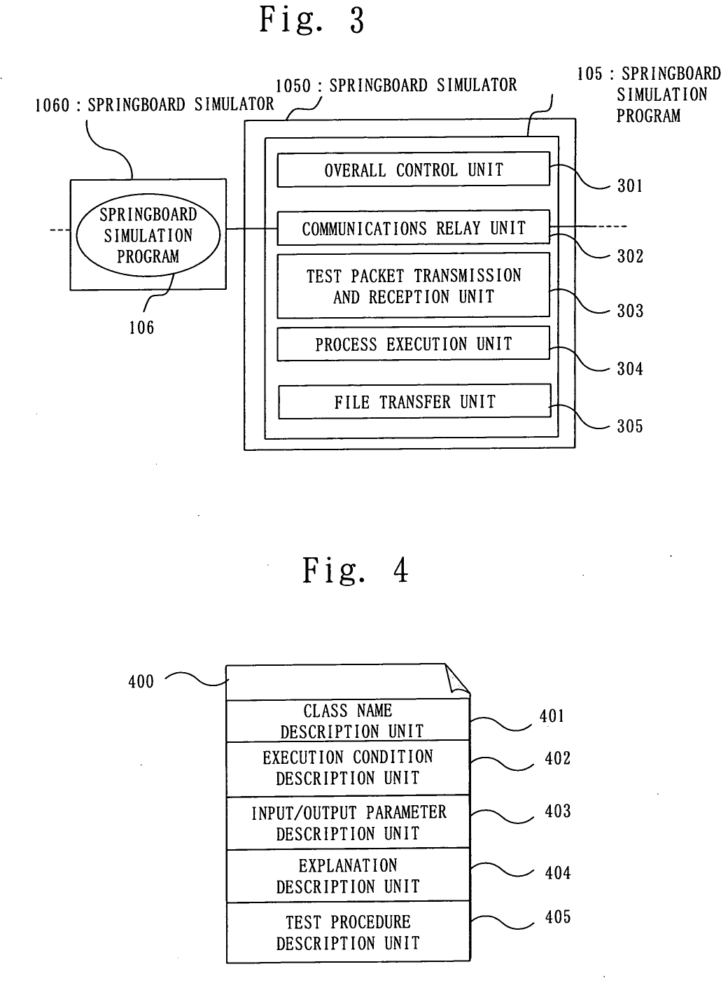

Now, an inner configuration of the springboard simulation program 105 that the springboard simulator 1050 of FIG. 1 executes will be described with reference to FIG. 3. The springboard simulation program 105 includes an overall control unit 301, a communications relay unit 302, a test packet transmission and reception unit 303, a process execution unit 304 and a file transfer unit 305. The communications relay unit 302 communicates with the springboard simulation program 106 of another springboard simulator 1060 or the springboard simulation program control unit 205 of FIG. 2 over a network.

The overall control unit 301 receives a control message transmitted through the communications relay unit 302, and operates the test packet transmission and reception unit 303, the process execution unit 304, and the file transfer unit 305 in accordance with instructions of the control message. In case of receiving the control message addressed to one other than itself, the overall control unit 301 transfers the control message by use of the communications relay unit 302 to the right destination.

The communications relay unit 302 transfers the control message. The communications relay unit 302 can connect one parent with two or more children. Therefore, the springboard simulators 1050 are connected to each other in a tree structure with the vulnerability test apparatus 100 at the top.

The connection is made by TCP and a TCP connection request is available from a child to a parent or from a parent to a child.

Now, an operation of the present system will be discussed with reference to FIG. 2.

Initially, the user 101 requests the test execution unit 202 via the operation unit 201 to provide with a list of the scripts 102 available for execution. The test execution unit 202 calls the script control unit 203 as an inner means thereof.

The script control unit 203 retrieves the scripts 102 one by one from the script accumulation unit 206, and accumulates the file name and the contents of the input/output parameter unit 403, the explanation description unit 404, and the class description unit 401 of each script in the list. When repeating this process through all the scripts 102, the script control unit 203 returns the list to the user 101 via the operation unit 201.

Then, the user 101 selects the script 102 that he desires to execute from among the list (list) of the tests, and requests via the operation unit 201 the test execution unit 202 to execute a test. The request includes (1) a script name or a class name, (2) information about a test parameter, and (3) a test end condition (with class name in (1) only). The test execution unit 202 requests the script control unit 203 to execute the test. An execution result is returned to the operation unit 201.

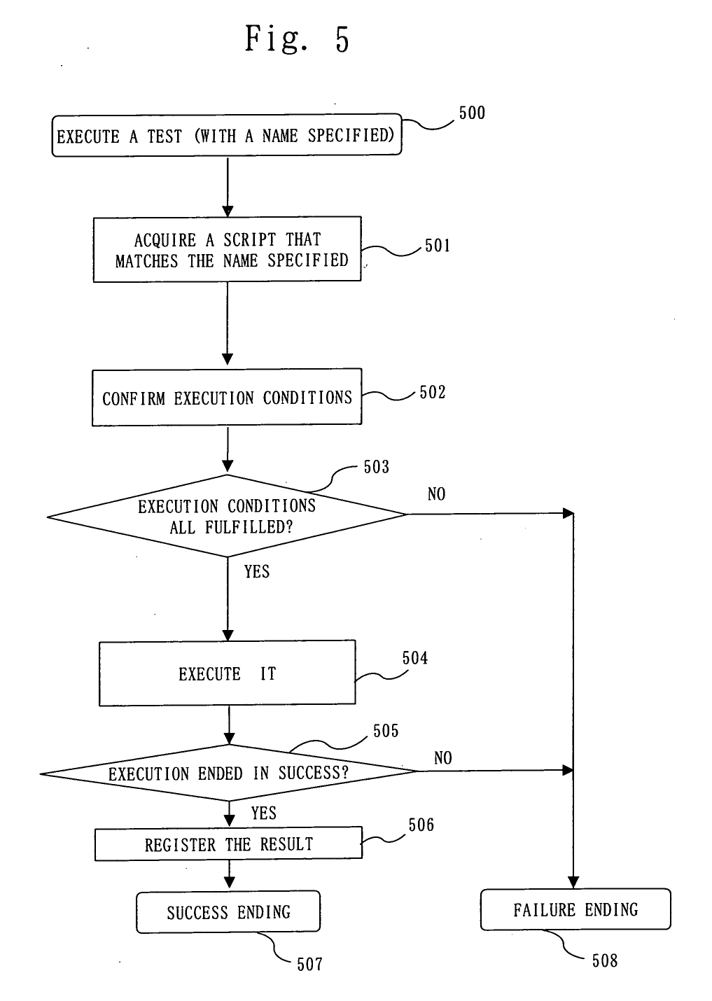

Now, an operation of the script control unit 203 will be discussed with reference to FIG. 2, FIG. 4, and FIG. 5. Firstly, a description will be given of the case where a test is executed with a test name specified.

In step 501, the script control unit 203 upon reception of the test execution request retrieves the script 102 that is managed by the file name specified in the script accumulation unit 206.

Then, in step 502, the script control unit 203 retrieves the contents of the execution condition description unit 402 described in the script 102. The execution condition description unit 402 of the script 102 has a predicate calculus based description about conditions required for executing the script 102, such as that the OS of the test target host computer 107 should be of Windows (registered trade mark). The script control unit 203 transfers the conditions to the knowledge sharing unit 103 so as to verify whether or not the execution conditions are met.

Then, in step 503, it is judged whether or not the execution conditions have been met based on a reply from the knowledge sharing unit 103. If the execution conditions have not been met, the process of the script control unit 203 proceeds to step 508 in which the process ends because the execution of the script 102 failed.

If the execution conditions have been met, the process proceeds to step 504 in which the script control unit 203 executes a test in accordance with the contents of the test procedure description unit 405 of the script 102 and test parameters included in the test execution request.

In step 505, an execution request of the script is judged, and in the case of a failure, the process goes on to step 508 in which the process ends.

In some cases where executions succeeded, new knowledge may be acquired such as a list of security holes discovered. Such knowledge is stored in the shared knowledge accumulation unit 208 in the knowledge sharing unit 103 in step 506 so that it is reused in other tests.

Finally, the execution result is returned to a calling source, and the process ends (step 507).

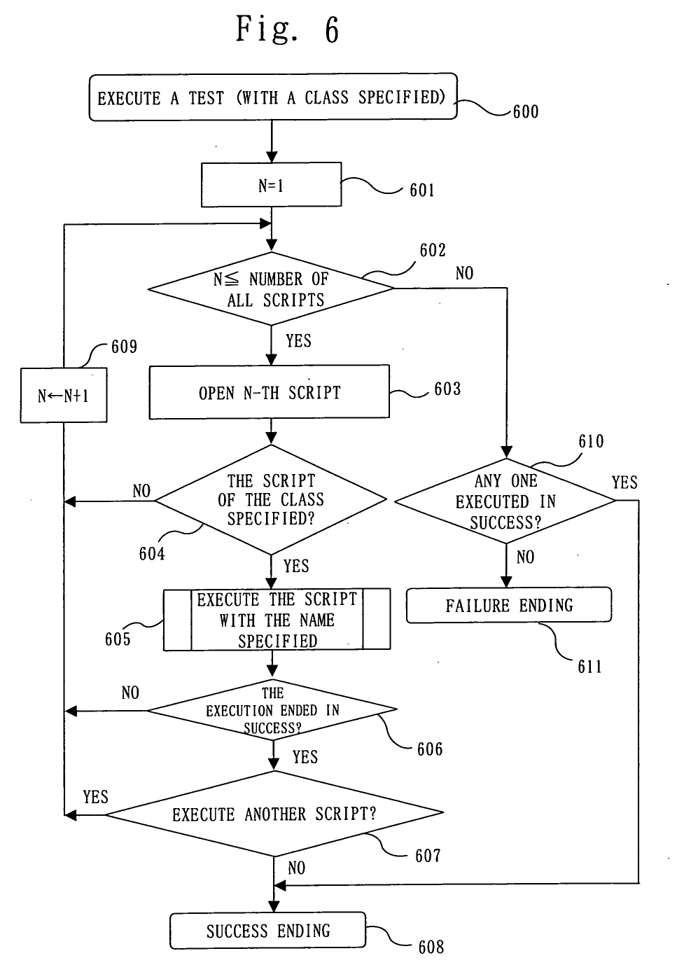

Now, a description will be given of the case where a test is executed with a class name specified with reference to FIG. 6.

The script control unit 203 upon reception of the test execution request executes a loop from step 601 to step 607, thereby retrieving the scripts 102 stored in the script accumulation unit 206 one by one, and performs the following operations.

First in step 604, with reference to the class name description unit 401 of the current target script 102, it is examined whether or not the particular script 102 belongs to the class specified by the test execution request.

If that script 102 does not belong to the class 102 specified by the test execution request, then the process proceeds to step 609 in which to process a next script 102.

If that script belongs to the class specified by the test execution request, in step 605, an execution of the script 102 is attempted. More particularly, the process starts from step 502 of FIG. 5.

In step 606, it is judged whether the execution ended in success or failure. If it ended in failure, the process proceeds to step 609 in which to try another script 102 for execution.

If the execution ended in success, it is judged in step 607 whether or not to execute another script 102 of the same class. The judgement is made based on a test end condition included in information given as the test execution request.

If the test end condition is “to execute all the scripts of the same class”, then the process proceeds to step 609 in which another script 102 is tried for execution. Otherwise, the process proceeds to step 608 in which an execution result is returned to a calling source, and then the process ends.

In step 602, it is determined whether or not all the scripts 102 were tried for execution. If it is determined that all the scripts 102 have been tried for execution, then the process proceeds to step 610.

In the case where at least one of the scripts 102 has been executed in success before the step 610, the process proceeds to step 608 in which an execution result is returned to a calling source, and the process ends. In the case where none has been executed in success, then the process proceeds to step 611 in which the process ends because the test execution process failed.

That describes the process in the case where the script execution is requested by the user 101. As aforementioned, however, it is also possible to call one script 102 from another script 102. In this case, the data to be given to the script control unit 203 and the subsequent process are the same except for the calling source.

Now, an operation of the plugin control unit 204 will be discussed with reference to FIG. 2. The plugin control unit 204 is called by the script control unit 203 when the script control unit 203 executes a plugin execution command described in the test procedure description unit 405 in the script 102. Data to be given at the time of calling includes the name of the plugin 104 to be executed and an execution parameter that the plugin 104 requires.

The plugin control unit 204 retrieves from the plugin accumulation unit 207 and executes the plugin 104 corresponding to the plugin name that is received as a parameter. An execution result is returned to the script control unit 203 as the calling source, and finally to the script 102 as the consequence of the plugin execution command.

The plugin 104 operates the springboard simulation program 105 while executed via the springboard simulation program control unit 205. The springboard simulation program 105 to be operated is specified by the address of the host computer in which the program is running and a unique springboard simulation program identifier in the hose computer. Commands that can be requested to the springboard simulation program 105 are as follows:
to Create/Scrap a TCP/UDP/RAW socket;
to Bind a socket (TCP/UDP) to a local port;
to Connect a socket (TCP/UDP) to a remote port;
to Send or Recv via a connected socket;
to SendTo or RecvFrom via a non-connected socket;
to Start/End the Process;
to Exchange data via a standard input/output of a started Process;
to Transfer a file from a vulnerability test apparatus host to a springboard simulation program operation host and vice versa, and acquire the status of the springboard simulation program; and
to Stop a springboard simulation program.

Now, an operation of the knowledge sharing unit 103 will be described with reference to FIG. 2. The knowledge sharing unit 103 accumulates knowledge obtained through a test in the knowledge accumulation unit 208 and is used for allowing it to be reused in other tests.

The deduction unit 108 makes a deduction based on knowledge in the knowledge accumulation unit 208 about whether or not there is a solution that satisfies a given goal. The present means is called by the script control unit 203 for verification of the execution condition of the script 102. In the case where a description of shared knowledge acquisition commands is included in the script 102, the deduction unit may be called while the script is executed.

The knowledge is described based on predicate calculus, and the deduction is made by a deduction system based on predicate calculus such as Prolog. The knowledge accumulation unit 208 may accumulate not only factual knowledge that is obtained through tests but also deduction rules using variables.

In addition, a special predicate having a property of executing the scripts 102 has been defined. If the deduction rules are described based on this predicate, the script 102 can be executed to acquire knowledge for making up for the insufficiency of shared knowledge. This allows automatically calling another script 102 in order to meet the execution conditions of one script 102.

Normally, the deduction rule is read from a default file (knowledge file) at the time of initialization of a system, and set in the shared knowledge accumulation unit 208. However, the deduction rule may also be added in a test process. Furthermore, accumulated knowledge may also be stored in the default file (knowledge file).

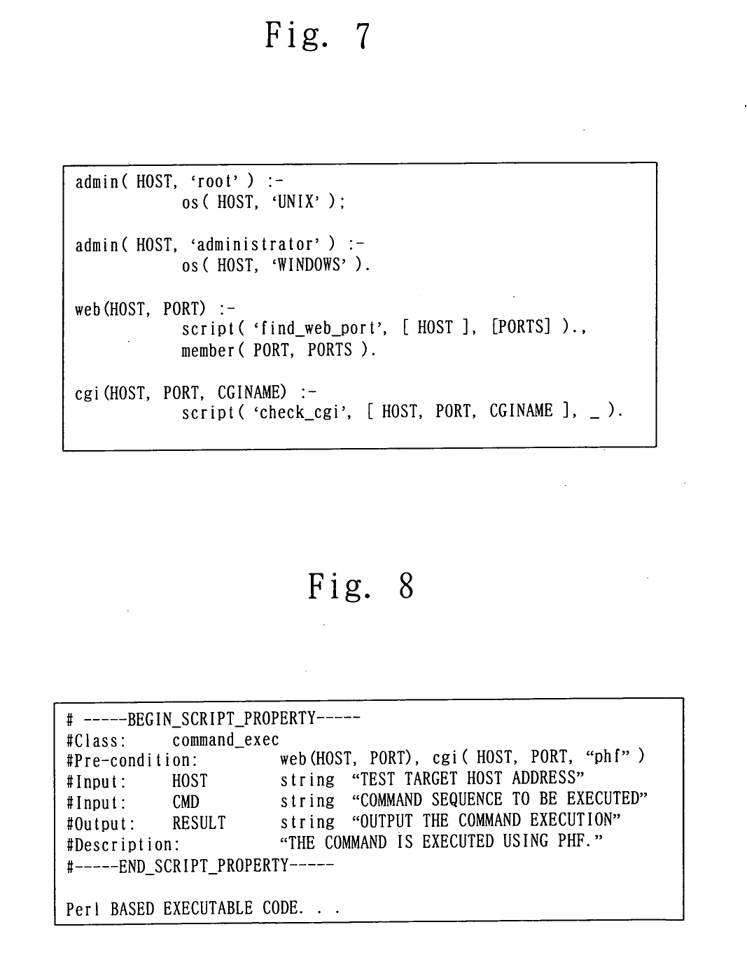

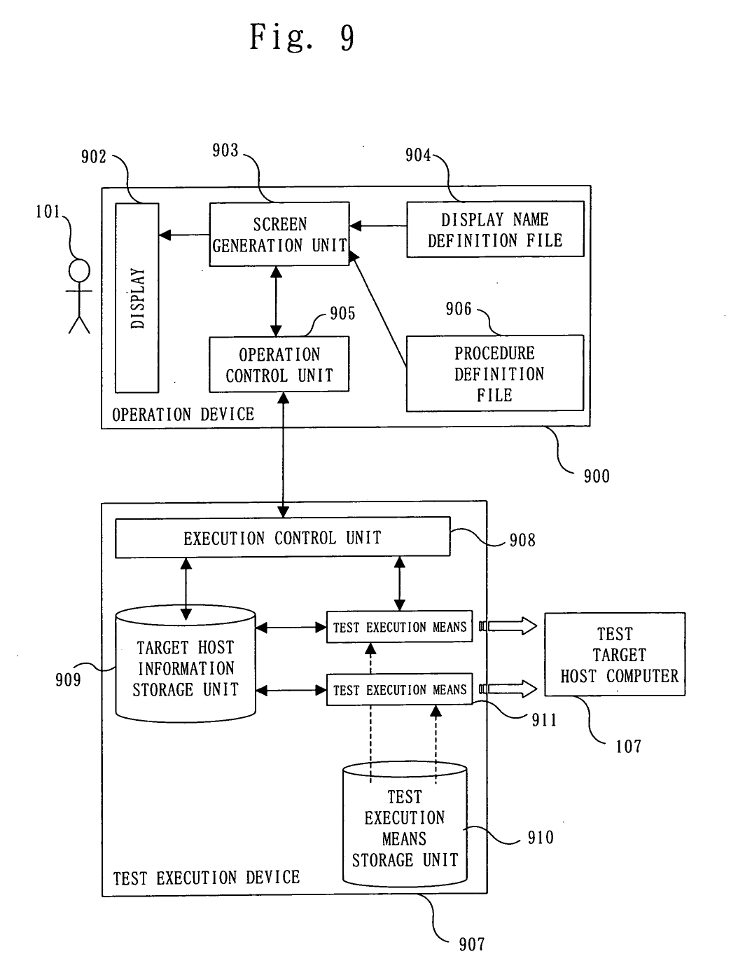

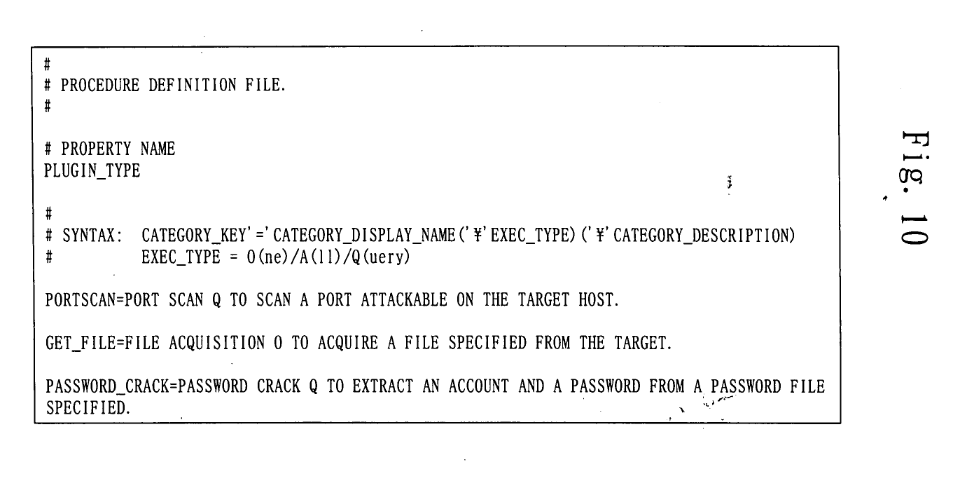

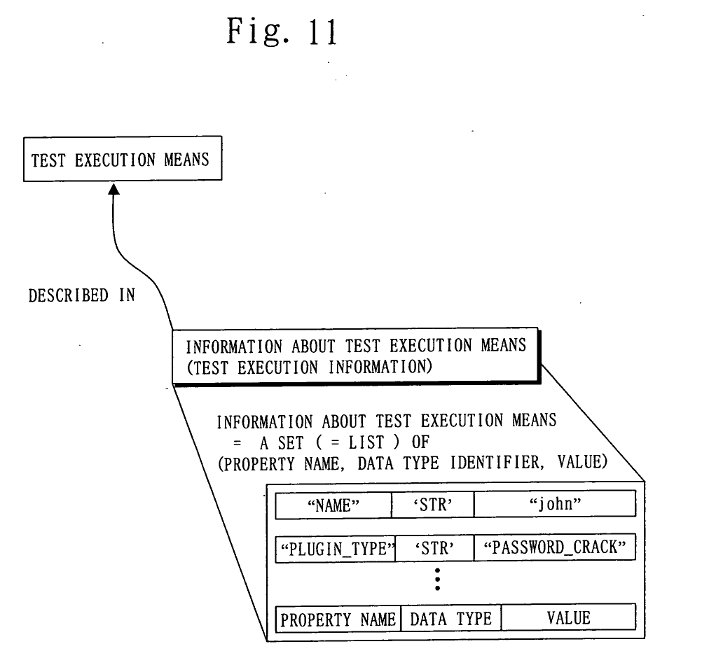

FIG. 7 shows an example of the knowledge file. The syntax is based on the Prolog grammar in this embodiment.

The system described in this embodiment allows implementing a security hole diagnostic system characterized as follows.

Firstly, describing a test scenario as the script 102 in a programming language and calling the plugin (corresponding to the test execution unit) 104 automatically from the script 102 allows executing a complicated test.

Further, exchanging parameters between the test execution units by the agency of the script 102 may remove the necessity of the user having knowledge about the input/output relationship between the test execution units.

Further, allowing one script 102 to call another script 102 may implement a scenario in hierarchy.

Further, allowing new knowledge to be derived from the shared knowledge based on the deduction rules may remove the necessity of elaborating the deduction logic for each script 102/plugin 104.

Further, allowing the plugin 104 to execute a test via the springboard simulation program 105 may implement a test scenario via the same springboard as that of a real attacker.

Further, including the concept of class in the scripts allows grouping by class name, so that one script may be called from another script by use of not only the file name of the script by also the class name thereof.

### Embodiment 2

The operation unit 201 and the test execution unit 202, which are installed in the same apparatus according to the first embodiment, may also be disposed separately on a network.

The system described in this embodiment allows implementing a security hole diagnostic system characterized as follows.

In addition to the characteristics described in the first embodiment, the test execution unit may be disposed outside of a firewall and the operation unit may be disposed inside of the firewall. This allows reducing the security risk of disposing the present system on a network.

### Embodiment 3

The plugin 104, which is implemented by a dynamically loadable shared library according to the first embodiment, may also be implemented by an interpreter language that is available for interfacing with the springboard simulation program control unit 205.

The system of this embodiment allows implementing a security hole diagnostic system characterized as follows.

In addition to the characteristics described in the first embodiment, the plugin 104 becomes easier to install and also becomes easily editable while the system is running.

### Embodiment 4

For communications between the springboard simulation programs 105 and 106 and between the springboard simulation program 105 and the vulnerability test apparatus 100, unique TCP/IP protocols are used in the embodiments, but it is also possible upon consideration of firewall to employ general communication protocols such as HTTP and SMTP that are designed to pass firewalls.

The system described in this embodiment allows implementing a security hole diagnostic system characterized as follows.

In addition to the characteristics described in the first embodiment, communications with the springboard simulation program may be protected from being cut off by a firewall, and thus a test may be conducted with a more similar attack scenario to that of a real attacker.

### INDUSTRIAL APPLICABILITY

Thus, the present invention allows executing a complicated test by describing a test scenario as the script in a programming language and calling the plugin (corresponding to the test execution unit) automatically from the script.

In addition, exchanging parameters between the test execution units through the script 102 may remove the necessity of the user having knowledge about the input/output relationship between the test execution units.

1. A security hole diagnostic system comprising:
a script accumulation unit accumulating a plurality of scripts in a programming language describing procedures usually used by attackers for illegal access;
an operation unit making a request for a list of the plurality of scripts upon entry from a user;
a script control unit retrieving each script from the script accumulation unit upon the request from the operation unit, creating a list of an input/output parameter, a script execution condition and a test procedure described thereof, and presenting the list to the user, and executing a script that is selected by the user;
a plugin accumulation unit accumulating plugins with logics for attacking individual security holes; and
a plugin control unit, which is called by an execution of the script by the script control unit, for retrieving from the plugin accumulation unit a plugin that is specified by the script to be executed and executing the plugin on a test target computer.

2. The security hole diagnostic system according to claim 1, comprising:
a springboard simulation program including a packet transmission/reception function, a process start/end function, a function to input/output data to/from a process, and a file transfer function; and
a springboard simulation program control unit executing the plugin on the test target computer via the springboard simulation program upon instruction from the plugin.

3. The security hole diagnostic system according to claim 1, wherein the script is constructed to have a function to allow it to call another script.

4. The security hole diagnostic system according to claim 1, wherein the script includes class concept, and
wherein the script is constructed to have a function to allow it to call another script by specifying a class name when calling the another script.

5. The security hole diagnostic system according to claim 1, comprising:
a knowledge sharing unit verifying whether the script execution condition is met,
wherein the knowledge sharing unit includes,
a deduction unit deriving new knowledge from information collected in an execution process of the script based on a deduction rule.

6. The security hole diagnostic system according to claim 5, wherein the knowledge sharing unit is constructed to have a function to execute a script for acquiring knowledge based on the deduction rule when shared knowledge is insufficient.

7. The security hole diagnostic system according to claim 2, wherein the script control unit, the plugin accumulation unit, the plugin control unit, the script accumulation unit, and the springboard simulation program control unit form a test execution unit, and the test execution unit and the operation unit are disposed separately on a network.

8. The security hole diagnostic system according to claim 1, wherein the plugin is described in an interpreter language.

9. The security hole diagnostic system according to claim 2, wherein the springboard simulation program control unit is constructed by using a protocol designed to pass firewalls.
